(19) United States
(12) Patent Application Publication
(10) Pub. No.: US 2007/0221391 A1
(43) Pub. Date: Sep. 27, 2007

(54) Apparatus, accessories and/or controls attached to a drill of any sort for screwing, impacting and/or drilling into anything; including different position's and controls for grasping or positioning a drill of any sort to function

(76) Inventor: Kenneth George Pospisil, Florence, AL (US)

Correspondence Address: KEN POSPISIL, 1421 CR 316, FLORENCE, AL, 35634, US

(21) Appl. No.: 11/389,826

(22) Filed: Mar. 27, 2006

(51) Int. Cl. B23B 45/00

(52) U.S. Cl. 173/170; 16/430

(57) ABSTRACT

An attachment for use in assisting a user in supporting a tool on the hand and arm of the user, the tool having a tool width and a transverse central longitudinal axis includes a hand grip that is connected to the tool via a pair of braces. The length of the hand tool is such to accomodate a user's hand, and is substantially perpendicular to said longitudinal axis of the tool. A kick bar is connected to the tool along the longitudinal axis of the tool and between the braces. When the user grasps the hand grip by inserting fingers between the hand grip and the tool, the kick bar will rest on the arm of the user to bear the weight of the tool. A power switch may be incorporated into the handle or braces for engagement by the user to control operation of the tool.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of electric, cordless or pneumatic drills and more specifically to an apparatus, accessories and/or controls attached to any drill of any sort for screwing or impacting anything into or away from the work; Offering different postion's and controls for grasping or positioning a drill of any sort to function.

### Historically

Drilling has definitely come a long way compared to the old style of drilling.

The old methods involved manually spinning slim piece's of steel tapered and threaded at the end in order to make holes or threads.

Later on came the “U” Shaped offset drill which had to have pressure put on it from the back, and in which had the tip of the drill bit threaded in order to drill holes.

Then came electricity which revolutionized the world with amongst all things the first electric drill.

The shape and contour of that first drill has not changed at all. That drill was and is the same as a cylindrical metal or plastic body with a handle positioned under the drill and the hand facing to the front along with the trigger in the front. It is the same as it was back then.

The most recent versions of the electric, cordless and pneumatic drill involve a vertical handle or grip to control the device, and a switch mounted somewhere on the handle for the finger to activate the power to drill.

The entire weight, control and handling of the drill rests on the wrist, hand and arm.

Prior and most recent versions of the electric, cordless or pneumatic drills have several deficiency's interfering with it's most basic usability.

Acting as a counter productive weight (because of it's center of gravity ), lowering, raising and maneuvering, by it's nature, tends to cause a drag or positioning problem on the wrist.

This in turn causes premature fatigue on the wrist, fingers and also arms.

The forward thrusting motion is also inherently flawed biometrically since the positioning of the drill for the point of pressure is angled 90 degrees below the hand or offset from the hand, making it difficult at times to put forward pressure to drill an exact location.

This positioning creates fatigue in the finger's, hand's and most of all the wrist's.

### BRIEF SUMMARY OF THE INVENTION

The primary object of the invention is a more comfortable and contour drill to the arm and wrist.

Another object of the invention is an Easier way of drilling or holding a drill or Camera of any sort.

Another object of the invention is a more Efficient way of drilling wood, steel or any other hardware.

Further object of the invention is it allows for lighter screwing and drilling.

Yet another object of the invention is Providing a drill that is less strenuous on the muscles and fatigue free.

Still yet another object of the invention is a drill that is more Manuverable, Controllable, Comfortable and offers a huge Stability factor for precise drilling for positioning.

Another object of the invention is it Relives the old problem of fatigued pressure on the thumb and wrist.

Another object of the invention is that it Ergonmolically conforms to the arm making the drill or handle a part of the body.

A further object of the invention is it's great position for vertical and horizontal drilling.

Yet another object of the invention is a Portable or stationary drill.

Still yet another object of the invention is it could be used as portable electric, cordless, corded electric or pneumatic.

Other objects and advantages of the present invention will become apparent from the following descriptions, taken in connection with the accompanying drawings, wherein, by way of illustration and example, an embodiment of the present invention is disclosed.

The Magnum E-Z Drill handle is a welcome sight to the do-it yourselves, hobbyists or the professionals as it adds a condition of stability, function strength.

Ergonomically designed for comfort to the arm, wrist and finger, the Magnum E-Z Drill will prove itself out to drill more accurate, precise and fatigue less than older models of electric, cordless or pneumatic drills.

The positioning under the perpendicular bar as the hand slides under it makes the bar and the hand more part of the body than older versions.

Now the arm not the wrist, as in older versions, is now a part of the load bearing pressure given to the work.

### BRIEF DESCRIPTION OF THE DRAWINGS

The drawings constitute a part of this specification and include exemplary embodiments to the invention, which may be embodied in various forms.

It is to be understood that in some instances various aspects of the invention may be shown exaggerated or enlarged to facilitate an understanding of the invention.

FIG. 1. is a Perspective view of the invention.
A. Body of the drill
B. Magnum EZ-Drill Handle
C. Padded contour underside
D. One of several possible positions for power switches
E. Another possible position for a power switch
F. Detachable battery, could be detached and fastened on the body (ie. a construction workers tool belt)
G. Possible articulated hinge of body on drill
H. Hand grasp of Magnum EZ-Drill
I. A solar panel supplying power on any part of the body or anywhere, connected to the drill through or to an electrical circuit or battery.

FIG. 2 is a Elevation View of the invention.

FIG. 3 is a Electrical Schematic Circuit view of the invention.

FIG. 4 is a Exploded view of the invention.

FIG. 5 is a Plan view of the invention.

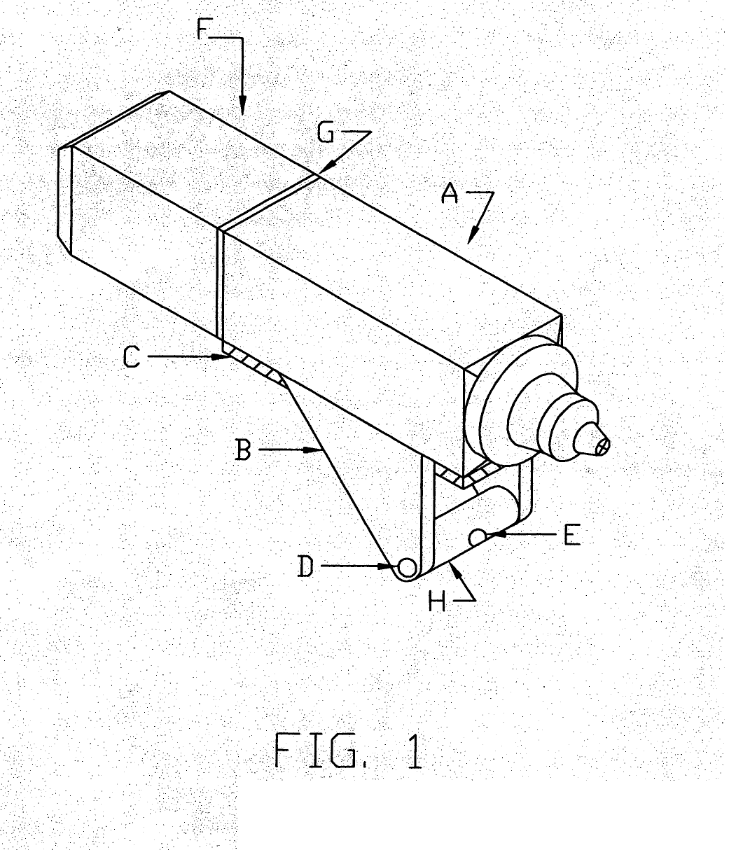

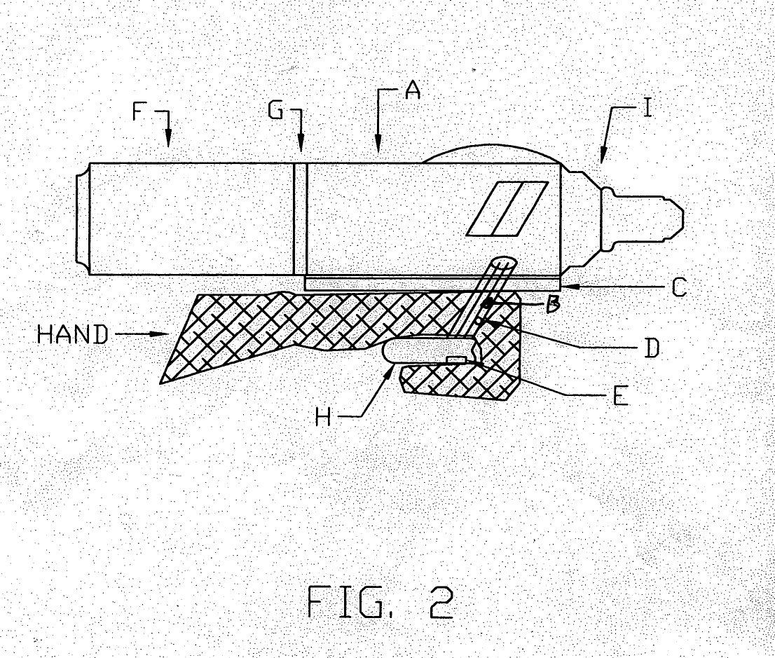

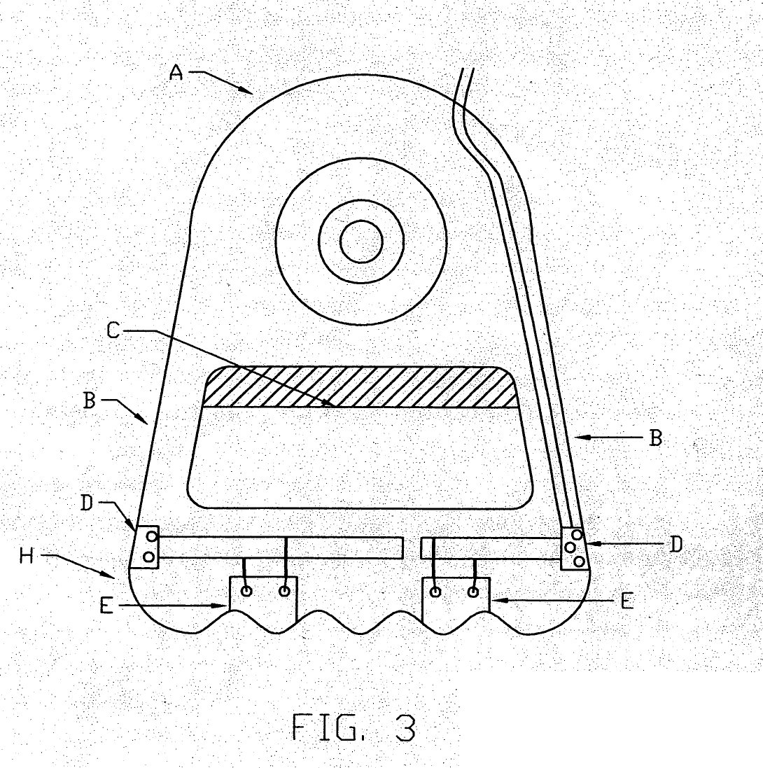

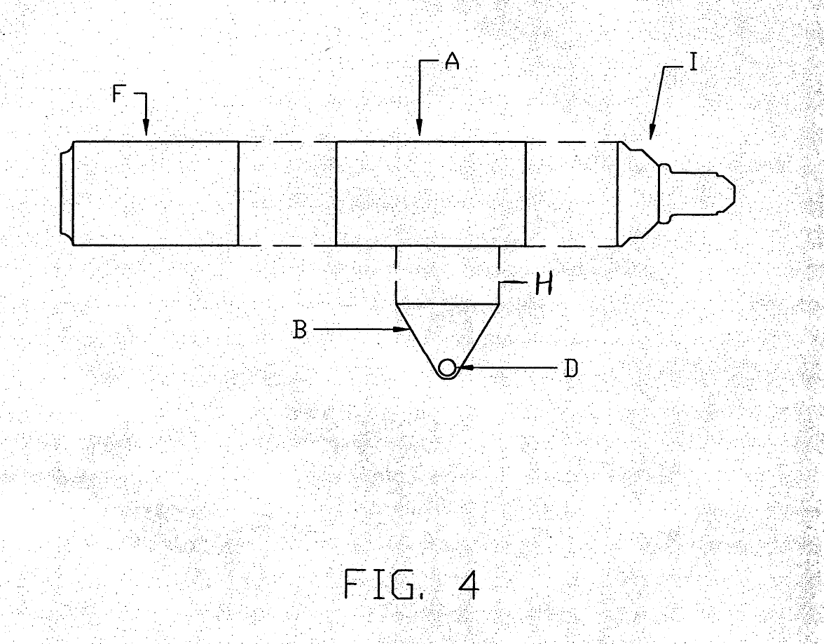

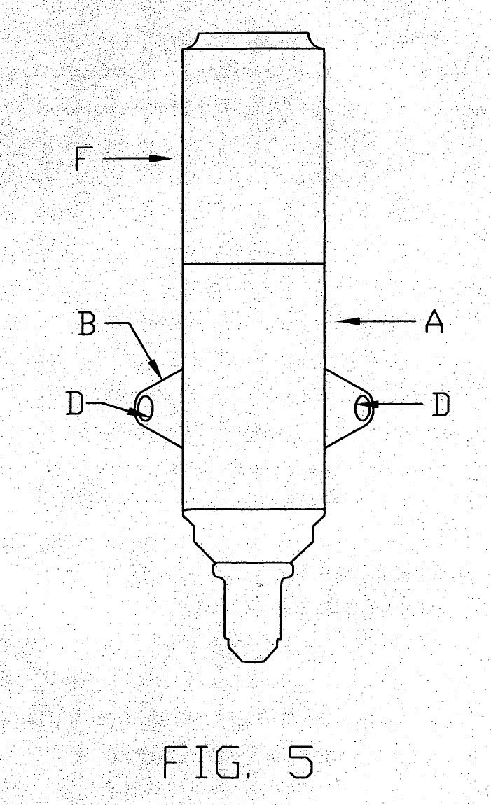

### DETAILED DESCRIPTION OF THE PREFERRED EMBODIMENTS

Detailed descriptions of the preferred embodiment are provided herein. It is to be understood, however, that the present invention may be embodied in various forms.

Therefore, specific details disclosed herein are not to be interpreted as limiting, but rather as a basis for the claims and as a representative basis for teaching one skilled in the art to employ the present invention in virtually any appropriately detailed system, structure or manner.

Turning first to Page 1. There is shown a drill device of some sort with a bar or handle Fig. H, extending perpendicular to the drill body, Fig. A.

On page 1 an important feature allows you to place your hand through B the body of the Magnum E-Z Drill handle to accomplish drilling.

Turning to Page 1. Fig. F, A battery is attached to Fig. A, the body of the drill.

To accomplish an important function of the invention, there is shown in Page. 1, Fig. D and E, an on and/or off finger or thumb switch to control the speed, and/or the forward reverse motion of the drill.

It is ascertained that the position of the Magnum E-Z Drill handle Fig. H is a perpendicular position leaving alignment of the hand in a more natural way.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. (canceled)

2. An attachment for use in assisting a user in supporting a tool on the hand and arm of the user, the tool having a tool width along a widthwise axis and a transverse central longitudinal axis, the attachment comprising:
a kick bar connected to the tool along the longitudinal axis of the tool;
a pair of braces connected to the tool on opposite sides of said kick bar; and
a hand grip mounted between said pair of braces, said hand grip being substantially perpendicular to said longitudinal axis and parallel to the widthwise axis of the tool for the hand of the user to clutch said hand grip and said kick bar to rest on the arm of the user.

3. The attachment as described in claim 2, wherein said braces extend outward from said central longitudinal axis of the tool, and said hand grip having a grip length, said grip length being greater than the tool width.

4. The attachment as described in claim 2, further comprising:
a power switch integrally connected with said hand grip for engagement by the user to activate the tool.

5. The attachment as described in claim 2, further comprising:
a switch integrally connected with one of said braces for engagement by the user to control operation of the tool.

6. The attachment as described in claim 5, wherein said switch is selected from the group consisting of a trigger, lever, button or toggle.

7. The attachment as described in claim 2, said hand grip having a wave outline for grasping by the hand of the user.

8. The attachment as described in claim 2, further comprising means for connecting said braces to the tool.

9. The attachment as described in claim 8, wherein said brace connecting means is selected from the group consisting of molded braces to the tool, mounted braces to the tool, bolted braces to the tool, glued braces to the tool, and screwed braces to the tool.

10. The attachment as described in claim 2, further comprising means for connecting said kick bar to the tool.

11. The attachment as described in claim 10, said kick bar connecting means is selected from the group consisting of molded kick bar to the tool, mounted kick bar to the tool, bolted kick bar to the tool, glued kick bar to the tool, and screwed kick bar to the tool.

12. In a power instrument for use by an operator, the power instrument having a housing surrounding a tool, the housing having a width along a widthwise axis and a transverse central longitudinal axis, wherein the improvement comprises:
a handle connected to the housing, said handle including a pair of braces and a grip positioned between said pair of braces, said grip being substantially perpendicular to the longitudinal axis and parallel to the widthwise axis; and
a kick bar affixed to the housing between said pair of braces to rest on an arm of the operator.

13. The improvement described in claim 12, wherein said braces extend outward from said central longitudinal axis of the tool housing, and said grip having a grip length, said grip length being greater than the tool width.

14. The attachment as described in claim 12, further comprising:
a power switch integrally connected with said grip for engagement by the user to activate the tool.

15. The attachment as described in claim 12, further comprising:
a switch integrally connected with one of said braces for engagement by the user to control operation of the tool.

16. The attachment as described in claim 15, wherein said switch is selected from the group consisting of a trigger, lever, button or toggle.

17. The attachment as described in claim 12, said grip having a wave outline for grasping by the hand of the user.

18. A handle assembly for use in assisting an operator in supporting a tool on a hand and an arm of the operator, the tool having a tool width along a widthwise axis and a transverse central longitudinal axis, the handle assembly:
a padded underside connected to the tool along the longitudinal axis of the tool;
a pair of braces connected to the tool on opposite sides of said padded underside; and
a hand grip mounted between said pair of braces, said hand grip being substantially parallel to the widthwise axis of the tool and perpendicular to the longitudinal axis of the tool for the hand of the user to clutch said hand grip and said padded underside to engage the arm of the operator to support the tool.

19. The handle assembly as described in claim 18, wherein said braces extend outward from said central longitudinal axis of the tool, and said hand grip having a grip length, said grip length being greater than the tool width.

20. The handle assembly as described in claim 18, further comprising:
a power switch integrally positioned in said hand grip, said power switch in electrical communication with the tool for engagement by the operator to activate the tool.

21. The handle assembly as described in claim 18, said hand grip having a wave outline for grasping by the hand of the operator.
